(19) United States
(12) Patent Application Publication
(10) Pub. No.: US 2011/0042916 A1
(43) Pub. Date: Feb. 24, 2011

(54) MONOCOQUE STRUCTURE OF AN ELECTRICALLY POWERED MOTORIZED VEHICLE

(76) Inventor: Anil ANANTHAKRISHNA, NORCROSS, GA (US)

Correspondence Address: SEAN LIAM KELLEHER;Kelleher IP PLLC, 4 Manorshire Dr, Ste 1, Fairport, NY, 14450, US

(21) Appl. No.: 12/704,524

(22) Filed: Feb. 11, 2010

Related U.S. Application Data
(60) Provisional application No. 61/151,829, filed on Feb. 11, 2009.

(51) Int. Cl. B62K 19/00

(52) U.S. Cl. 280/287

(57) ABSTRACT

The present invention describes a unique monocoque structure of an electrically powered motorized vehicle. In one embodiment, the structure includes at least two front wheels, wherein the pitch of the front wheels can be extended; at least two rear wheels, wherein the pitch of the rear wheels can be extended; and a monocoque frame suspended between the front wheels and the rear wheels. Further, a control switch is mounted on the monocoque fame to convert two wheeled vehicle to three or four wheeled vehicle and vice versa. Furthermore, the monocoque frame is built with combinations of die-cast, extrusions of high strength plastic and light metal alloys to provide light weight and sufficient rigidity.

### RELATED APPLICATIONS

Benefit is claimed under 35 U.S.C. 119(e) to U.S. Provisional Application Ser. No. 61/151,829, entitled “MONOCOQUE STRUCTURE OF AN ELECTRICALLY POWERED MOTORIZED VEHICLE” by Anil Ananthakrishna, filed Feb. 11, 2009, which is herein incorporated in its entirety by reference for all purposes.

### FIELD OF THE INVENTION

The present invention generally relates to the field of automobiles. Particularly, the present invention relates to a structure of an electrically powered motorized vehicle and more particularly, it relates to a unique monocoque structure of an electrically powered motorized vehicle to maximize energy efficiency and automobilist's safety.

### BACKGROUND OF THE INVENTION

Over the last 150 years, bicycles have been one of the most efficient means of transportation and over a period of time these included an efficient gear system to minimize physical effort while riding. Of late, conventional bicycles have been replaced by electrically powered motorized vehicles which are now ruling the market because of various reasons like pollution control, easy to use etc.

In recent years, significant efforts have gone into developing electrically powered motorized vehicles that have optimized power and efficiency. However, there exists certain limitation in the range, power, efficiency and other performance characteristics due to the weight of the heavy batteries in the electrically powered motorized vehicles. The batteries have a low energy density and yield less energy than gasoline fuels of similar initial weight. Generally, the electrically powered motorized vehicles are heavier compared to the internal combustion engine powered vehicles due to the additional weight of the batteries in the electrically motorized vehicle.

Conventional electrically powered motorized vehicles typically employ heavy tube frame structures with an array of brackets to support the batteries and the electric motor. This construction often results in a mass fraction for the electric motor driven cycle that is less than optimal. The mass fraction refers to the percentage that the batteries contribute to the overall weight of the electric motor driven cycle. Also, for a given amount of force, the less the mass applied to, the higher the speed that will result and more the mass applied, the lower the speed that will result. Increased performance in terms of extended range can often be obtained by increasing the mass fraction. One way to increase the mass fraction is to reduce the weight of the frame. This tends to increase the range of the electrically powered motorized vehicle for a given battery weight.

Therefore, from the foregoing, there exists a need for a unique monocoque structure for an electrically powered motorized vehicle to achieve light weight, increased mass fraction, maximize efficiency and also provide automobilist safety.

### SUMMARY OF THE INVENTION

The primary aspect of the present invention is to provide a unique monocoque structure of an electrically powered motorized vehicle to maximize energy efficiency and automobilist's safety.

In one aspect, the unique monocoque structure of an electrically motorized vehicle includes at least two front wheels, wherein the pitch of the front wheels can be extended; at least two rear wheels, wherein the pitch of the rear wheels can be extended; and a monocoque frame suspended between the front wheels and the rear wheels.

Accordingly, the present invention relates to the vehicle structure, wherein the pitch of the front wheels and the rear wheels can be close enough to provide single wheel traction for a two wheeled vehicle. Also, the pitch of the front wheels and/or the rear wheels is extendable to provide three or four wheeled vehicle through a control switch, which is mounted on the monocoque fame.

In another aspect, the monocoque frame of the electrically powered motorized vehicle includes one or more compartments to house the internal components of the vehicle. Further, the internal components of the vehicle can be strategically positioned for optimal performance.

In yet another aspect, the monocoque frame of the electrically motorized vehicle is built with combinations of die-cast, extrusions of high strength plastic and light metal alloys to provide light weight and sufficient rigidity.

These and other objects, features and advantages of the present invention will become more apparent from the ensuing detailed description of the invention taken in conjunction with the accompanying drawings.

### BRIEF DESCRIPTION OF DRAWINGS

Example embodiments are illustrated by way of example and not limitation in the figures of the accompanying figures, in which like references indicate similar elements and in which:

FIG. 1 is a side view of a two wheeled electrically powered motorized vehicle, wherein FIG. 1(a) is a side view of the vehicle with two piece monocoque structure and FIG. 1(b) is a side view of the vehicle with three piece monocoque structure, in accordance with the present invention.

FIG. 2(a) is a top view of a three wheeled electrically powered vehicle and FIG. 2(b) is a top view of a four wheeled electrically powered vehicle, in accordance with the present invention.

Other features of the present embodiments will be apparent from the accompanying drawings and from the detailed description that follows.

### DETAILED DESCRIPTION OF THE INVENTION

The preferred embodiments of the present invention will now be explained with reference to the accompanying drawings. It should be understood however that the disclosed embodiments are merely exemplary of the invention, which may be embodied in various forms. The following description and figures are not to be construed as limiting the invention and numerous specific details are described to provide a thorough understanding of the present invention, as the basis for the claims and as a basis for teaching one skilled in the art about making and/or using the invention. However in certain instances, well-known or conventional details are not described in order not to unnecessarily obscure the present invention in detail.

The present invention describes an extruded unique monocoque structure of an electrically powered motorized vehicle for minimizing production time, maximizing mechanical stability, maximizing heat dissipation, protection against corrosion and adaptability to camouflage aesthetically to different body shapes. The word ‘vehicle’ and ‘electrically motorized vehicle’ are used interchangeably through out the document. Also, the word, ‘chassis’ and ‘frame’ are used interchangeably through out the document.

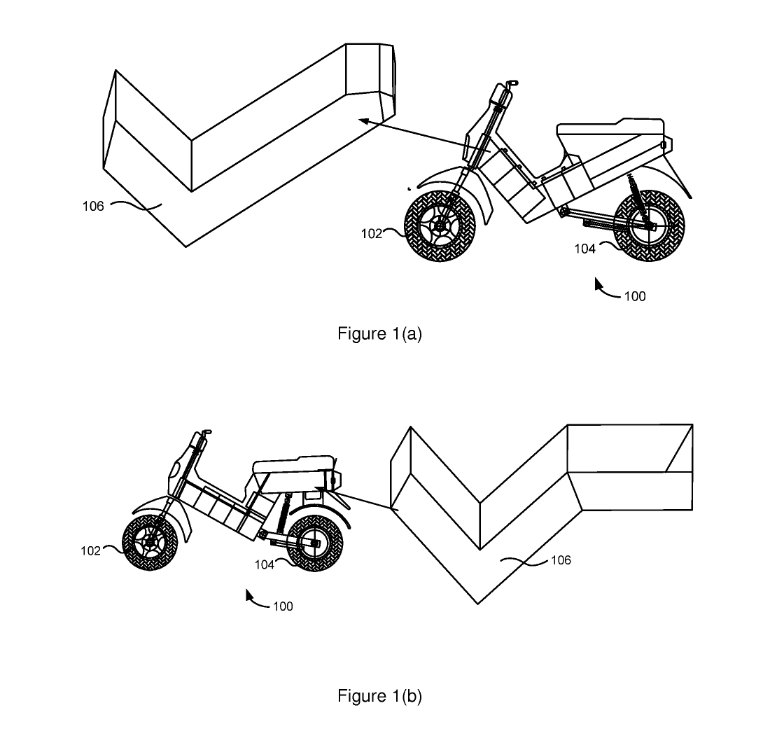

FIG. 1 is a side view of an exemplary electrically powered motorized vehicle (100), in accordance with the present invention. In one embodiment, the structure of the electrically powered motorized vehicle (100) includes at least two front wheels (102), wherein the pitch of the front wheels (102) are closed enough to form a single wheel; at least two rear wheels (104), wherein the pitch of the rear wheels (104) are closed enough to form a single wheel; and a monocoque frame (106) suspended between the front wheels (102) and the rear wheels (104). In general, the pitch of the front wheels (102) and rear wheels (106) are close enough to provide for single wheel traction, i.e., two wheeled vehicle as shown in FIG. 1. The monocoque frame (106) is a unitary structure with one or more compartments to house the internal components of the vehicle (100) such as power pack, control system, monitoring system etc., bearing the major portion of the stresses.

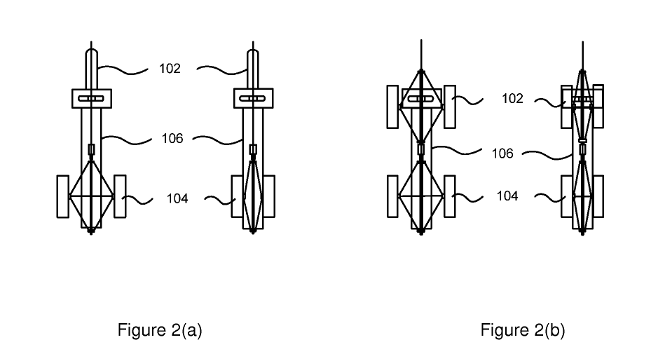

In one exemplary implementation, the monocoque frame (106) design can be two piece monocoque as shown in FIG. 1(a) or three piece monocoque as shown in FIG. 1(b). The front wheel (102) and the rear wheel (104) are designed such that each wheel can be extended to form three or four wheeled vehicle which are illustrated in FIG. 2.

In one exemplary embodiment, the building blocks of the monocoque frame (106) are made with combinations of materials such as die-cast, molded and/or extrusions to the desired shape, size and functional requirement, hence removing the need for permanent fastening of constituent elements with welded joints and associated after effects like burr removal, cleaning, grinding etc. Further, the unique monocoque chassis (106) is preferably made up of high strength plastic or light metal alloys or combinations of both. Particularly, the monocoque chassis (106) is preferably formed by a composite of materials containing aluminum and polyurethane. The monocoque chassis (106) is molded in polyurethane foam along with heat dissipating aluminum material. In addition, the seat section as the cover for the chassis in aluminum is also conceptualized in polyurethane, which is molded in such a way that the bottom sections are hard and tough for mounting and top section is soft and comfortable for seating.

In one embodiment, the monocoque frame (106) having light weight also include sufficient rigidity to support the internal components of the vehicle (100). Therefore, the mass fraction of the vehicle (100) is optimized for higher performance in terms of extended range, capability, energy efficiency etc. In addition, the monocoque frame provides a high degree of design flexibility with respect to the location of the internal components within the frame. Thus, the internal components of the vehicle (100) can be strategically positioned for optimal performance.

In one embodiment, at nominal and high speed, each wheel's (front wheel (102) and the rear wheel (104)) pitch is close enough to provide for single wheel traction, thus the vehicle behaves as a two wheeler as shown in FIG. 1. At lower speeds, the automobilist can opt for extending wheel pitch for better balancing, stability and comfort through a control switch suitably mounted on the vehicle to form three or four wheeled vehicle as shown in FIG. 2(a) and FIG. 2(b) respectively. In operation, the senses from the control switch are passed on to the electrically powered motor, preferably placed perpendicular to that of a mechanical arm provided on the rear end of the chassis. The expansion of the mechanical arm in turn extends the wheel pitch apart to a predetermined distance to convert two wheeled vehicle to a three or four wheeled vehicle as shown in FIG. 2(a) and FIG. 2(b). It is advantageous that easy conversion from a two wheeled vehicle to a three or four wheeled vehicle maximizes balance and comfort of the automobilist and conversion of three or four wheeled vehicle to a two wheeled vehicle provides for better approachability in dense traffic conditions as a two wheeler. Further, the structure is designed with utmost simplicity of assembling and disassembling from the monocoque chassis to reach the inner part sand glove box of the vehicle.

In addition, the cooling is achieved through injecting molten composite material into the mold cavities under high pressure and the solidified cast blocks are removed by natural air cooling and/or forced air cooling with ducting integrated in the forms of the structure.

It is advantageous that the extruded monocoque structure as detailed above eliminates the need for prefabrication of building blocks consisting of steel tubes, requirement of fixtures, alignment problems, raw material storage space and warp age.

In general, it is clear that the present invention and its advantages are not limited to the above described embodiments only. With minor modifications, substitutions and equivalents will be apparent to those skilled in the art without departing from the spirit and scope of the present invention as described in the claims. Accordingly, the specification and figures are to be regarded as illustrative examples of the invention, rather than in restrictive sense.

We claim:

1. A unique monocoque structure of an electrically powered motorized vehicle comprising:
at least two front wheels, wherein the pitch of the front wheels can be extended;
at least two rear wheels, wherein the pitch of the rear wheels can be extended; and
a monocoque frame suspended between the front wheels and the rear wheels, wherein the monocoque frame can be of at least two piece monocoque structure.

2. The vehicle structure of claim 1, wherein the pitch of the front wheels and the rear wheels can be close enough to provide single wheel traction for a two wheeled vehicle.

3. The vehicle structure of claim 1, wherein the pitch of the front wheels and/or the rear wheels are extendable to provide three or four wheeled vehicle.

4. The vehicle structure of claim 3, wherein a control switch is mounted on the monocoque fame to convert two wheeled vehicle to three or four wheeled vehicle and vice versa.

5. The vehicle structure of claim 1, wherein the monocoque frame comprises one or more compartments to house the internal components of the vehicle.

6. The vehicle structure of claim 5, wherein the internal components of the vehicle can be strategically positioned for optimal performance.

7. The vehicle structure of claim 1, wherein the monocoque frame is built with combinations of die-cast, extrusions of high strength plastic and light metal alloys to provide light weight and sufficient rigidity.

8. The vehicle structure of claim 7, wherein the light metal alloy used can be aluminum to avoid electromagnetic interference.

9. The vehicle structure of claim 7, wherein the monocoque frame is molded in polyurethane foam along with heat dissipating aluminum material.

10. The vehicle structure of claim 1, wherein the cooling of the vehicle is provided by natural air cooling and/or forced air cooling with ducting integrated in the monocoque structure.
